(19) United States
(12) Patent Application Publication
(10) Pub. No.: US 2009/0125449 A1
(43) Pub. Date: May 14, 2009

(54) Systems and methods for determining investment product suitability

(75) Inventors: Jeffrey B. Levering, Harvard, MA (US); Jonas Burton, Melrose, MA (US); Stephen Powell, Westford, MA (US)

Correspondence Address: WOLF GREENFIELD & SACKS, P.C., 600 ATLANTIC AVENUE, BOSTON, MA, 02210-2206, US

(73) Assignee: NewRiver, Inc., Andover, MA (US)

(21) Appl. No.: 12/148,983

(22) Filed: Apr. 24, 2008

Related U.S. Application Data
(63) Continuation of application No. 11/999,750, filed on Dec. 7, 2007, now abandoned.
(60) Provisional application No. 60/873,750, filed on Dec. 8, 2006.

(51) Int. Cl. G06Q 40/00

(52) U.S. Cl. 705/36 R

(57) ABSTRACT

Techniques and systems are disclosed for determining the suitability of one or more investment products for an investor. One embodiment provides a method which includes receiving (e.g., via a graphical user interface, or GUI) information defining one or more characteristics of the investor, receiving (e.g., retrieving from an electronic file storage) information defining, for each of the investment products, at least one policy which pertains to investors in the product in a manner based at least in part on the characteristic(s) of the investor, processing the information to determine whether and/or how one or more policies apply to the investor, and presenting to a user (e.g., via the GUI) an indication of whether and/or how the policy(ies) apply(ies) to the investor, thus enabling the user to evaluate the suitability of the investment product(s) for the investor.

### RELATED APPLICATIONS

This application is a continuation of U.S. patent application Ser. No. 11/999,750, filed on Dec. 7, 2007, which claims priority under 35 U.S.C. § 119(e) to U.S. Provisional Application Ser. No. 60/873,750, filed on Dec. 8, 2006, which is herein incorporated by reference in its entirety.

### BACKGROUND OF INVENTION

Many investment products have characteristics and features which contribute to their suitability for particular investors. For example, mutual funds typically charge investors fees and expenses to pay for, for example, investment advisory services, transaction fees, marketing costs, distribution costs, and other operating expenses, and these fees may make some funds more suitable for certain investors than others. The amount each investor is charged may vary depending on, for example, the amount initially invested, whether additional ongoing investments and/or redemptions are planned, and various fund policies relating to fees and expenses. These fund policies may define, for example, whether a load is charged for fund trades, whether distribution (i.e., 12b-1) and/or management fees are charged, etc.

Although the Securities and Exchange Commission (SEC) requires each mutual fund to provide compliance information that defines fund policies relating to fees and expenses, these policies are generally very difficult for the average investor to interpret and analyze. For example, a fund's policies may not be set out in a single document, such that the investor may need to examine multiple documents to determine the fees and expenses associated with the fund. For example, a fund may first issue a prospectus setting forth policies, but then update the policies in a statement of additional information (SAI) or supplement, or both.

Further complicating matters is the fact that many mutual funds offer several share classes, each having different policies relating to fees and expenses. For example, many mutual funds offer a first class of shares that impose a “front-end” sales load (which is paid when the investor first buys shares in the fund), a second class of shares which imposes “back-end” sales load (which is paid when the investor redeems, or sells, the shares), and/or a third class which charges a “level load” (generally, a small front-end load and a back-end load which varies based on how long the investor holds the shares). Many funds charge 12b-1 and management fees in addition to loads, and these fees may vary by fund share class. In addition, some funds offer share classes which convert automatically to other share classes with lower back-end loads and/or fees if the investor holds the shares long enough. Many funds also offer share classes which employ breakpoints, which enable investors to be charged lower loads in return for investing larger amounts (the amount required to obtain a reduced sales load is referred to as the breakpoint).

### SUMMARY OF INVENTION

Applicants have appreciated that the complexity associated with determining the characteristics of investment products may make it difficult for many investors to compare different investment products to determine which investment product(s) are most suitable for them. Using the particular, non-limiting example of mutual funds to illustrate, the fees and expenses associated with owning different share classes of a fund may be difficult to discern, such that many mutual fund investors may find it difficult to determine which fund share class(es) is (are) most suitable for them, based on the investor's characteristics and situation, and the characteristics and policies (e.g., expenses) defined by the fund for various fund share classes. Accordingly, some embodiments of the invention provide systems and methods for evaluating the suitability of various investment products for one or more investors based on factors relating to the investor(s) and the investment product(s). Some embodiments of the invention may, for example, identify a particular investment product that is most suitable for a particular investor.

The suitability of an investment product for a particular investor may be evaluated based on any of numerous factors. Again using the particular, non-limiting example of mutual fund share classes, the loads, fees and expenses associated with various fund share classes may be compared, and the least costly share class (taking into account the investor's individual situation, such as the amount the investor is prepared to invest initially and over time, when the investor plans to redeem the investment, and/or other factors) may be identified as the most suitable investment product. Of course, the invention is not limited to evaluating suitability based on cost information, as any one or more evaluation criteria may be employed to determine the suitability of product for a particular investor, including, for example, any of various characteristics of the investor(s) and the investment product(s) and/or other information. For example, some embodiments of the invention may compare the tax treatment of different investment products to determine which is most suitable for a particular investor. In addition, embodiments of the invention are not limited to evaluating the suitability of mutual funds or share classes, as any type(s) of investment product(s) may be evaluated. For example, embodiments of the invention may evaluate the suitability of investment products such as stocks, bonds, variable annuities and/or 1035 exchanges, 529 and/or other educational investment or savings plans, Uniform Gift to Minors Act (UGMA) plans, and/or any other one or more investment products.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a flow chart depicting an example method of evaluating the suitability of one or more investment products for an investor, in accordance with some embodiments of the invention;

FIGS. 2A-2E each depict a representation of an example graphical user interface (GUI) which a user may employ to evaluate the suitability of one or more investment products for an investor, in accordance with some embodiments of the invention;

FIG. 3 is a block diagram depicting a system for evaluating investment product suitability, in accordance with some embodiments of the invention;

FIG. 4 is a block diagram depicting an example computer system on which embodiments of the invention may be implemented; and

FIG. 5 is a block diagram depicting an example computer system memory on which instructions defining aspects of the invention may be stored, in accordance with some embodiments of the invention.

### DETAILED DESCRIPTION

Some embodiments of the invention provide a system for evaluating the suitability of investment products for a particular investor. (It should be appreciated that the term “investor” is used herein in the singular for convenience, and that embodiments of the invention may be utilized to evaluate the suitability of investment products for any number of entities, such as one or more people, business organizations, other entities or a combination thereof. It should also be appreciated that use of the term “investor” does not mean that, at the time the suitability of an investment product is evaluated, the entity(ies) owns or holds a position in the investment product.) As intended herein, the suitability of any investment product to an investor is based upon any characteristic or set of characteristics of an investor and can vary based on application. The suitability determinator therefore should not be construed to be based upon any particular characteristic or set of characteristics. The examples of characteristics used herein are intended to be non-limiting examples.

In some embodiments, the system may present a graphical user interface (GUI) which a user (e.g., the investor, an investment broker, any other user, or combination thereof) may employ to supply various input relating to the investor, and which may present information relating to the suitability of various investment products for the investor. Information presented by the GUI may, for example, be retrieved from electronic file storage (e.g., one or more databases, which may store information relating to particular investment products and/or policies defined thereby), calculated or otherwise processed for presentation. The GUI may further enable the user to retrieve compliance documents which set forth one or more of these policies, so that the user may get clarification on certain policies and/or reference the documents in defining an investment strategy.

The suitability of various investment products for an investor may, in some embodiments, be based primarily on the costs associated with the investor owning each investment product. As a result, the input provided by a user may define how certain policies (e.g., defining fixed and/or variable costs) imposed by each investment product apply to the investor. For example, the user may provide input regarding the investor's planned initial investment, periodic investment over time, and planned redemption timeframe, because this may affect how loads and/or fees imposed by different mutual fund share classes may apply to the investor. However, the invention is not limited to such an implementation, and embodiments of the invention may enable a user to provide input defining any characteristic(s) of an investor, including, but not limited to, the investor's age, annual income, financial situation and needs, investment experience, investment objectives, intended use for the investment product(s), investment time horizon, existing assets, liquidity needs, liquid and/or overall net worth, risk tolerance, tax status, whether and how recently the investor has invested in the same or a different security in a prior time period, and/or any other information considered relevant by the user, investor or other party. Any one or more of these and/or other characteristics may be used to evaluate the suitability of the investment product(s) for the investor.

Embodiments of the invention may also, or alternatively, enable a user to provide input defining characteristics of one or more investment products. For example, if certain information relating to a particular investment product is not accessible by the system, embodiments of the invention may enable a user to provide this information, and incorporate it into the evaluation of one or more related products. For example, embodiments of the invention may enable a user to specify characteristics such as charges (e.g., redemption fees and/or surrender charges), attributes (e.g., if the investment product is a variable annuity or similar product, the terms, conditions and benefits specified in the underlying contract), exchange conditions (e.g., if an exchange of investment products results in an enhancement or change in terms) and/or any other information considered relevant by the user, investor or another party. Any one or more of these investment product characteristics may then be used to evaluate the suitability of an investment product for the investor.

A specific, illustrative, non-limiting example is given below relating to evaluating the suitability of different share classes offered by a mutual fund for a particular investor. In this example, a GUI allows a user to provide input relating to the investor and the investor's investment strategy and situation, and this input defines the application of one or more policies for each fund share class to the investor. Based at least in part on the input, the GUI may cause information to be retrieved from electronic file storage relating to mutual funds, share classes and/or policies, and may present information that enables the user to evaluate the suitability of different share classes of the fund for the investor. While the example below is illustrative, embodiments of the invention may be implemented in any of numerous other ways, and employed to evaluate the suitability of any number and/or type of investment products. For example, embodiments of the invention are not limited to comparing different share classes offered by a particular mutual fund, and may, for example, enable a user to compare a share class offered by one mutual fund with a share class offered by another mutual fund, a mutual fund with another mutual fund, a mutual fund with one or more other types of investment product (e.g., a variable annuity), one or more investment products that do not include a mutual fund, and/or any other types of investment product(s). The invention is not limited to any particular implementation.

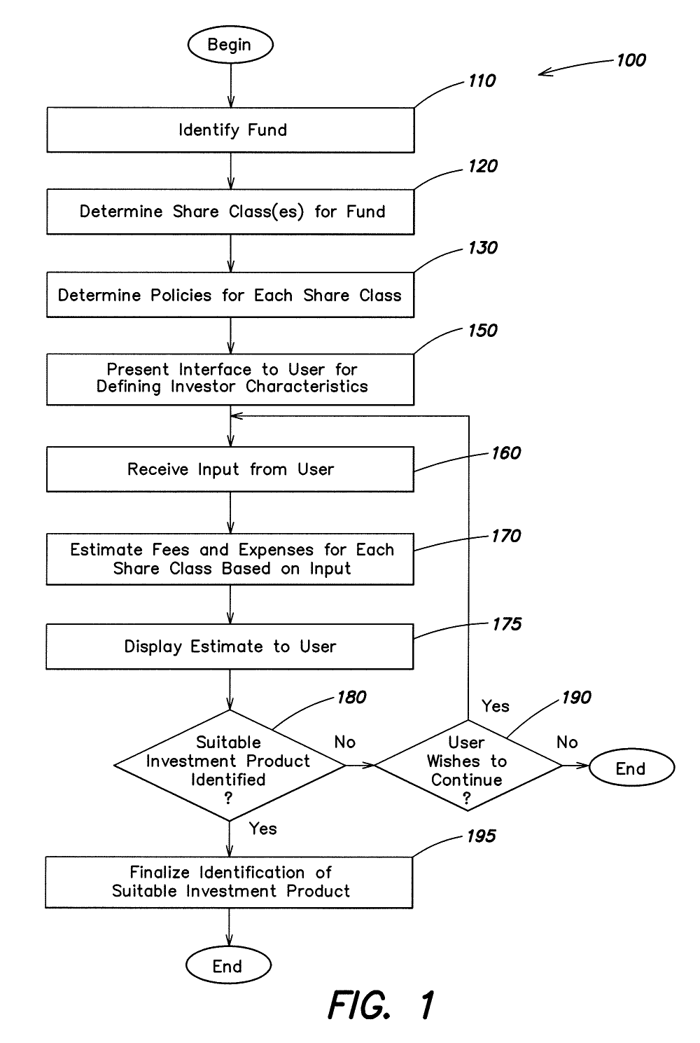

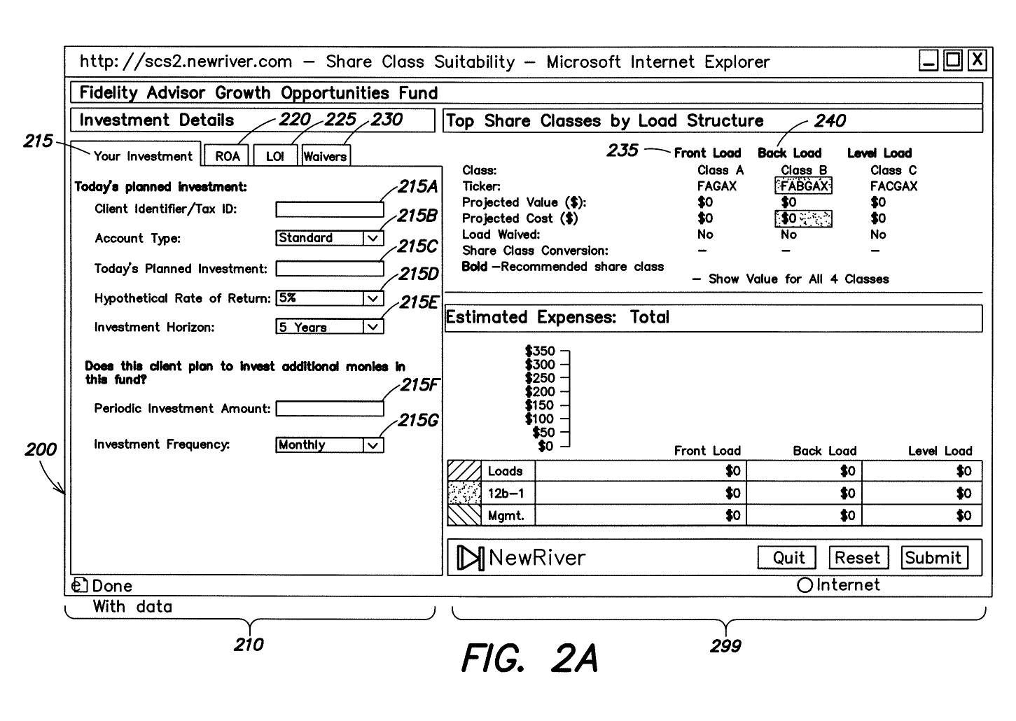

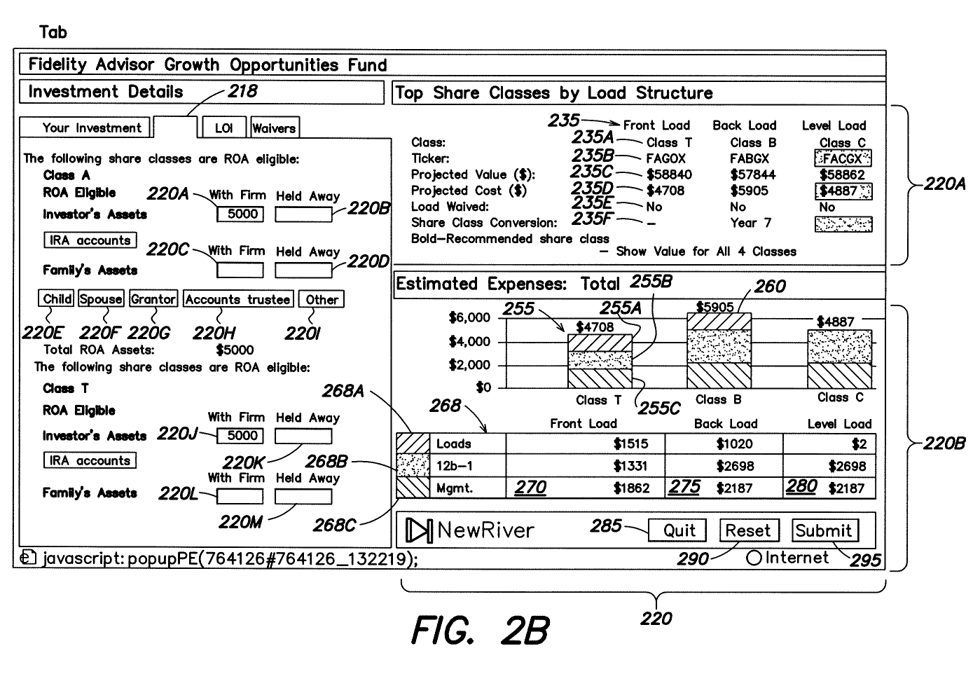

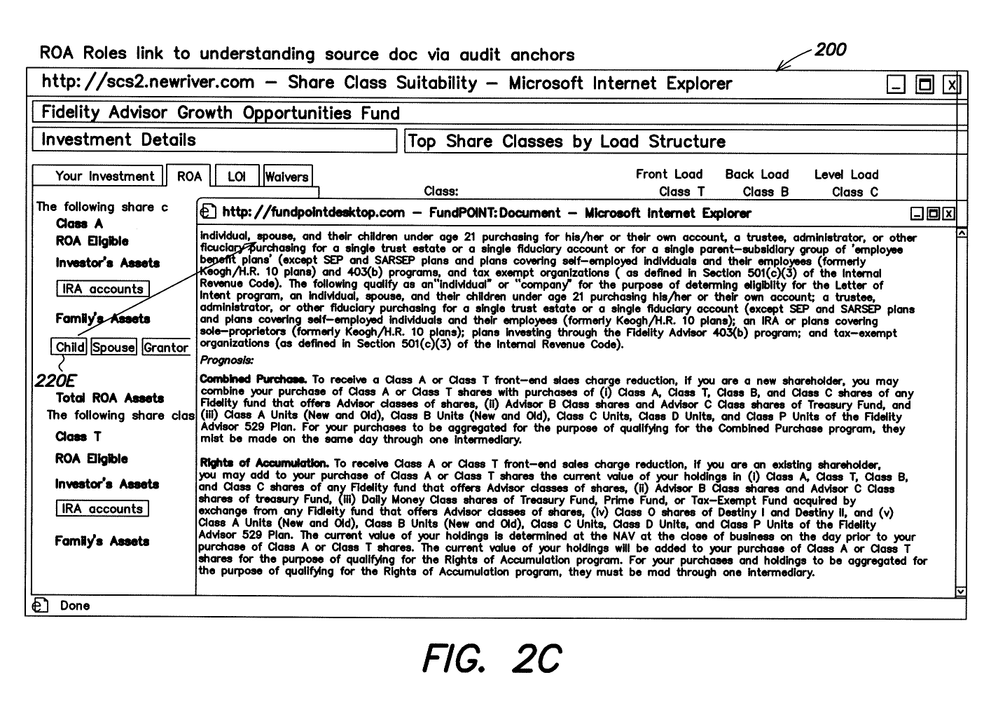

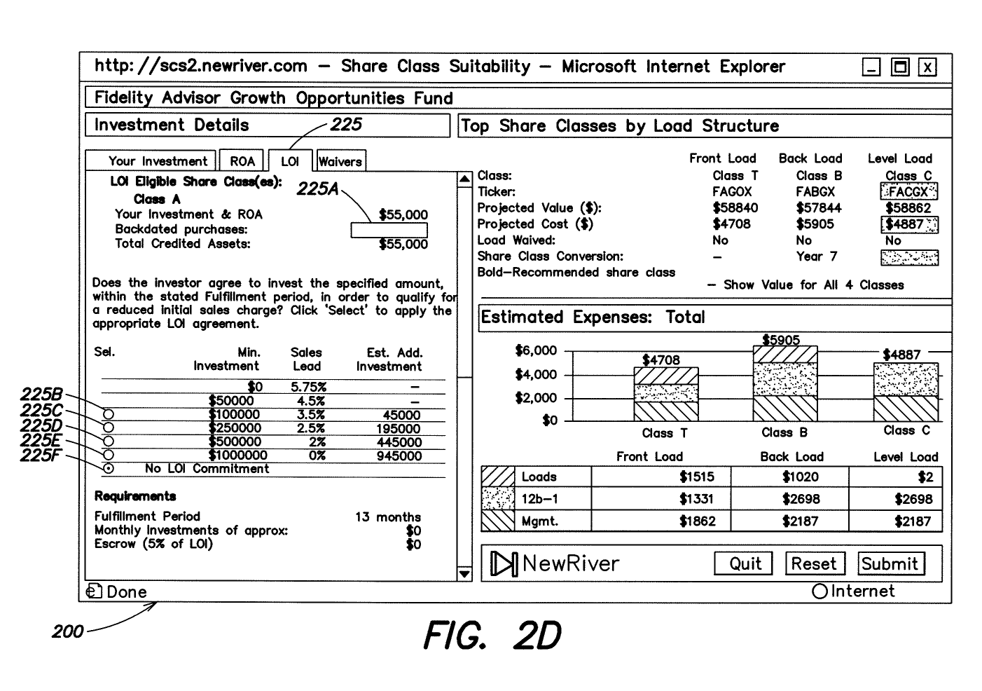

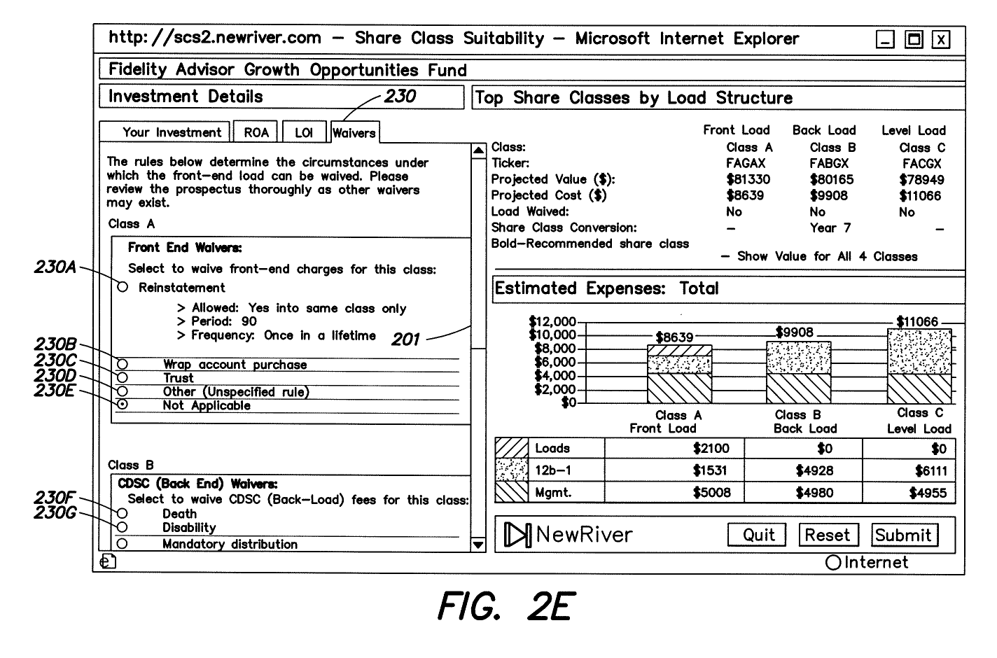

FIG. 1 depicts one example process 100 for evaluating the suitability of different mutual fund share classes for a particular investor. One or more of the acts in process 100 may be performed, for example, by a user employing a GUI, an example of which is depicted in FIGS. 2A-2E.

At the start of process 100, a particular mutual fund is selected for the investor. This selection may be based on any of numerous criteria. For example, the investor, or a representative thereof (e.g., a broker) may select a particular fund based on one or more characteristics of the investor, such as his or her investment strategy, risk tolerance, desired return, and/or other investor characteristics, or one or more characteristics of the fund, such as its previous performance, underlying holdings, investment strategy, and/or other fund characteristics.

Process 100 then proceeds to act 120, wherein the share classes for the fund are determined. This may be performed in any of numerous ways. In some embodiments, a database may be provided which stores information relating to various mutual funds, share classes, and/or policies. For example, in some embodiments, a database may be populated with compliance information extracted in an automated fashion from various compliance documents and information published by various mutual funds. An exemplary technique for performing this automated extraction and database population is described in commonly assigned U.S. Pat. No. 6,122,635, entitled “Mapping Compliance Information Into Useable Format,” which is incorporated herein by reference. Of course, other techniques may be employed, as the invention is not limited to a particular implementation. In some embodiments, act 120 includes performing a query on the database(s) storing this information to determine the share classes offered by the mutual fund selected in act 110.

The process then proceeds to act 130, wherein the policies for each share class are determined. As with the determination occurring in the act 120, act 130 may be performed by performing a query on the database(s) storing share class policy information. Performing a query may determine, for example, the particular loads, management fees and/or 12b-1 fees which apply to particular fund share classes, and an indication whether an investment amount, investor rights of accumulation, letters of intent, and/or waivers apply to particular share classes. Of course, any type of information relevant to share class policies may be determined, and the invention is not limited to determining that any particular type(s) of information. The particular types of information noted above are described in the paragraphs that follow.

The process then proceeds to act 150, wherein an interface is presented for defining investor characteristics (e.g., the characteristics determined in act 140). In some embodiments, a GUI is presented to a user that enables the user to specify this information. One example of an interface 200 designed to receive this information, and some example investor characteristics, is depicted in FIGS. 2A-2E.

In general, interface 200 includes two display portions, including investor information portion 210 and investment product information portion 220. To summarize the functionality of interface 200 at a high level, a user may supply information relating to an investor using any of various input mechanisms provided in portion 210, and based on the input provided, information relating to the policies (e.g., cost) of various fund share classes is displayed in portion 220. Of course, an interface implemented in accordance with embodiments of the invention may present any information in any fashion, as the invention is not limited to the particular implementation of interface 200.

Investor information portion 210 employs a tab metaphor which is well-known to those skilled in the computer programming art. As shown in FIG. 2A, when tab 215 (“Your Investment”) is selected (e.g., via a mouse click by the user), the tab presents various input mechanisms 215A-215G which the user may employ to provide input relating to the investor's investment amount. Specifically, input mechanism 215A allows the user to specify an identifier (e.g., a client or tax identifier) for the investor, and input mechanism 21 SB enables the selection of a particular account type for the investor from a dropdown list, which may be useful since different account types (e.g., individual, IRA, 401(k), etc.) may influence the fees and expenses which are imposed for a given share class. Input mechanism 215C enables the definition of an initial investment amount. Input mechanism 215D enables allows the user to define a desired rate of return, which may be useful because some fees and expenses may be asset-based and defined at least in part by the amount held in the investor's account at any one time. Input mechanism 215E allows the user to define an investment horizon, which may be useful because the time at which the investor plans to redeem his or her shares may affect back-end loads. Input mechanisms 215F-215G allow the user to specify future periodic investment, which may affect loads, fees and expenses charged over time.

FIG. 2B depicts various input mechanisms displayed when a user selects tab 218. In general, tab 218 allows the user to provide information relating to the investor's rights of accumulation, whereby the total value of other holdings by the investor, or a party related to the investor in some predefined way, may allow a lower load to be charged for a particular fund share class.

In the example shown, input mechanisms 220A and 220B allow the user to specify investor assets held with a particular firm (e.g., a firm with which the user is affiliated) and/or with other firms or entities, respectively. Input mechanisms 220C and 220D allow the user to specify assets held by various parties related to the investor, including (in the example shown) a child, spouse, grantor, account trustee, or other party. Other parties may be identified or represented in other examples. Input mechanisms 220E-220I enable the user to access compliance information relating to policies applying to these and/or other parties, such that the user may determine the investor's eligibility for various policies. For example, in some embodiments, user input (e.g., a mouse click) to any of input mechanisms 220E-220I may initiate a retrieval of a particular portion of a share class policy as defined by a compliance document. Retrieval may be performed, as an example, using the systems and methods defined by commonly assigned U.S. patent application Ser. No. 10/135,184, entitled “System For Locating Data Elements Within Originating Data Sources,” filed Apr. 8, 2004, which is incorporated herein by reference. Of course, the invention is not limited to using the systems and methods described therein, as any suitable processing technique(s) may be employed. The invention is not limited to a particular implementation.

Input mechanisms 220J-220K enable the user to specify assets held by the investor with the firm and with other firms or entities, similar to input mechanisms 220A-220B. Input mechanisms 220L-220M allow the user to specify assets held by parties related to the investor with the firm and other firms or entities, respectively, similar to input mechanisms 220C-220D.

FIG. 2D displays the various input mechanisms shown when a user selects tab 225. In general, selecting tab 225 causes information to be displayed which relates to a letter of intent to be executed by the investor to invest certain specified amounts over a predetermined period in order to become eligible for a lower sales load.

Input mechanisms 225B-225F enable the user to specify an additional investment (e.g., in addition to the amount specified using input mechanism 215C, FIG. 2A) to become eligible for a particular sales load. In the example shown, input mechanism 225B allows the user to specify that the investor will invest in additional $45,000 within the predetermined period, such that his or her total investment is $100,000, thereby allowing the investor to become eligible for a sales load of 3.5%. Similarly, button 225C enables the user to specify that the investor will invest an additional $195,000, such that his or her total investment is $250,000, thereby allowing the investor to become eligible for a 2.5% sales load.

It should be appreciated that by displaying the additional investment required to achieve a particular breakpoint level which allows the investor to be charged a lower sales load, the interface enables the investor (or user) to make a more informed decision relating to the amount to be initially invested. That is, the investor may select an optimal investment amount based on the policies of a particular investment product (e.g., fund share class). Some embodiments may provide other indications that allow an investor to make an informed decision as to how to qualify (or not qualify) for other fund policies.

For example, FIG. 2E displays input mechanisms which are presented when the user selects tab 230. In general, tab 230 displays information relating to circumstances under which the investor may qualify for a waiver of a load. In the example shown, a user may indicate that a particular circumstance applies which should cause a front-end load (i.e. associated with shares in “Class A”) to be waived for the investor. Specifically, input mechanism 230A allows the user to specify that the investor's holding in Class A is being reinstated (i.e., was previously sold by the investor within a defined period and is now being repurchased), input mechanism 230B allows the user to indicate that this is a wrap account (i.e., an account for which a brokerage charges a flat fee for managing the investor's portfolio covering all administrative, commission and management expenses), input mechanism 230C allows the user to specify that the investment is held in trust, input mechanism 230D allows the user to specify that another unspecified circumstance applies, and input mechanism 230E allows the user to specify that a front end waiver is not applicable.

Similar to input mechanisms 230A-230E, input mechanisms 230F-230G allow the user to indicate that a particular circumstances under which the investor may qualify for the waiver of a backend load. Specifically, input mechanism 230F allows the user to specify that the investor has died, and input mechanism 230G allows the user to specify that the investor has become disabled. Various other input mechanisms, allowing the user to specify that other circumstances apply, may become visible when the user scrolls down the interface (e.g., using scroll bar 201).

Returning to FIG. 1, upon the completion of act 150, process 100 proceeds to act 160, wherein various input is received which relates to characteristics of the investor. For example, user input may be provided via any of the input mechanisms presented upon the user's selection of one of tabs 215-230, as described above. For example, the user may provide information relating to an investment amount via the input mechanisms displayed by tab 215, rights of accumulation via the input mechanisms displayed by tab 218, etc.

In act 170, fees and expenses are calculated for each share class based on input provided in act 160. This may be performed in any of numerous ways. In some embodiments, predefined equations may employ as variables the input provided by the user via any of the input mechanisms described above, such that as the user provides this input fees and expenses are calculated in real time. For example, one or more program modules may include programmed instructions for performing these calculations, and may accept and process user input to calculate fees and expenses. As an example, if the user indicates via input mechanism 225B that the investor will invest an additional $45,000 over a predefined period, the program module(s) may receive and process this information such that the front-end load is calculated at 3.5% instead of 4.5% (i.e. the applicable rate for the investor's specified initial investment of $50,000) for Class A shares.

In act 175, the estimate of fees and expenses for each share class is presented to the user. In the embodiment shown in FIGS. 2A-2E, the estimate for each share class may be presented in portion 220. For example, FIG. 2B depicts fees and expenses for each share class based on user input provided via tab 218 (and/or any of tabs 215, 225 and portion 220 of interface 200 displays estimated expenses associated with different share classes. One example of this is shown in FIG. 2B. In this example, portion 220 includes areas 220A, which displays expense information in text form, and area 220B which displays expense information in graphical form. Area 220A presents expense information in the form of a table, wherein each column includes information relating to a particular share class, and wherein different types of information are presented in each row. As an example, column 235 includes information relating to a share class which charges a front end load, which information is displayed in rows 235A-235F. Area 220B displays cost information in graphical and tabular form. Specifically, bars 255, 260 and 265 indicate expenses associated with different share classes on a bar graph, and table 268 includes columns 270, 275 and 280, which correspond to the expense information provided by bars 255, 260 and 265, respectively. In the example shown, each bar includes three portions indicated by different shading, corresponding to rows 268A, 268B and 268C in table 268. Specifically, portion 255A represents load expense information shown at the intersection of row 268A and column 270, portion 255B shows 12b-1 expenses shown at the intersection of row 268B and column 270, and portion 255C shows management expenses shown at the intersection of row 268c and column 270. Bar 260 includes shaded portions corresponding to information stored at the intersection of rows 268A-268C and column 275, and bar 265 includes shaded portions corresponding to information stored at the intersection of rows 268A-268C and column 280.

Although the example shown in FIG. 2B presents information relating to particular costs associated with fund share classes, any information may be displayed. For example, information relating to past performance of each fund share class may also, or alternatively, be presented such that the user may be provided with information relating to each fund share class which incorporates both expected performance and cost information. Further, any information relating to cost associated with a particular fund share classes may be presented, as the invention is not limited to the particular cost information displayed in the examples shown in FIGS. 2A-2E. For example, cost information need not be limited to load, 12b-1 fee and management fee information (as shown in rows 268A-268C), as any suitable cost or cost-related information may be presented. The invention is not limited to a particular implementation.

Returning to FIG. 1, upon the completion of act 175, the process proceeds to act 180, wherein a determination is made whether an investment product has been identified which is suitable for the investor. Of course, this determination may incorporate many factors, and may be made in any suitable manner. For example, a user of interface 200 may determine that the investment product having the lowest associated cost shown is the most suitable for the investor, and may select this investment product. Using the example shown in FIG. 2B, the user may decide that the investment product having a cost totaling $4708.00 (as indicated by bar 255 and table cell 235d) is suitable for the investor because is represents the lowest cost investment product. Alternatively, the user may decide that none of the investment products presented have a sufficiently low cost for the investor and may wish to examine other investment products to determine the associate cost.

If it is determined in act 180 that a suitable investment product has not been identified for the investor, the process proceeds to act 190, wherein it is determined whether the user wishes to continue evaluating the suitability of investment products. The user may indicate that he or she does not wish to continue by providing input to (e.g., clicking) either of buttons 280 or 285. Specifically, by clicking button 280, the user may indicate that the investment product selection process should be concluded, and by clicking button 285 the user may indicate that the process should be reset (e.g., a new mutual fund and/or associated fund share classes, should be examined), such that process 100 may begin anew at act 110.

If it is determined in act 190 that the user wishes to continue, the process returns to act 160, such that the user may provide further information so that cost information may be recalculated and presented in act 170. However, if it is determined in act 165 that the user does not wish to continue, process 100 completes.

If it is determined in act 180 that a suitable investment product has been identified, the process proceeds to act 195, wherein the identification is finalized. In some embodiments, the user may finalize the identification of a particular investment product by providing input via button 295 which may cause an order for the particular identified investment product to be submitted. For example, information defining the amount invested, rights of accumulation, letter of intent and/or waivers provided via input mechanisms presented with tabs 215, 220, 225 and 230, respectively, may be transmitted to one or more program modules designed to initiate trade processing. For example, this information may define an order submitted by the user to a trade processing system on behalf of the investor.

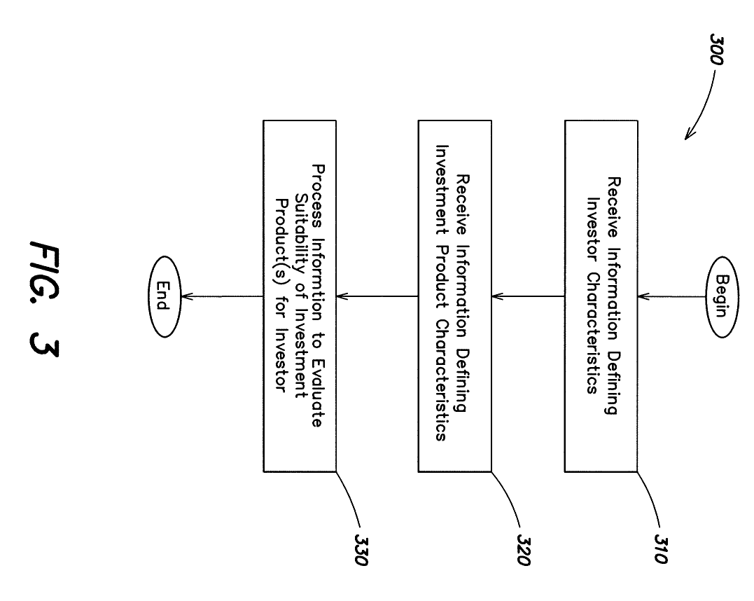

While a particular example was described above which relates to determining the fees and charges associated with different share classes of a mutual fund, as noted above, embodiments of the invention may be used to evaluate the suitability of any one or more types of investment products for an investor. In this regard, FIG. 3 depicts a process 300 which may be employed to evaluate the suitability of any one or more types of investment products for an investor, and thus is more generalized than the process described above with reference to FIGS. 1 and 2A-2E.

At the start of process 300, in act 310, information defining one or more investor characteristics is received. Information may be received in any suitable way, as the invention is not limited to any particular implementation. For example, information may be received via a graphical user interface similar in some respects to interface 200, described above with reference to FIGS. 2A-2E. An interface may receive any suitable information relating to an investor, such as the investor's age, annual income, financial situation and needs, investment experience, investment objectives, intended use for one or more investment products, investment time horizon, existing assets, liquidity needs, liquid and/or overall net worth, risk tolerance, tax status, whether and how recently the investor has invested in a particular security in a prior time period, and/or any other information considered relevant by the investor, user or other party.

Process 300 then proceeds with act 320, wherein information defining characteristics of one or more investment products is received. This information may also be received in any suitable fashion. For example, information relating to one or more investment products may be stored in electronic file storage, and queried to discern various characteristics and/or other related information. The information received may define any investment product characteristics, including any charges (e.g., redemption fees and/or surrender charges), attributes (e.g., if the investment product is a variable annuity or other product, the terms, conditions and benefits specified in an underlying contract), exchange conditions (e.g., if an exchange of investment products results in an enhancement or change in terms) and/or any other information considered relevant by a user, investor and/or other party. Any number and type of characteristics useful for evaluating the suitability of an investment product for an investor may be used, as the invention is not limited in this respect.

Process 300 then proceeds with act 330, wherein information received in acts 310 and 320 is processed to evaluate the suitability of one or more investment products for an investor. Information may be processed in any suitable way. For example, various policies, rules or other information relating to the investment products for which information is received in act 320 may be analyzed in relation to any investor characteristic(s) received in act 310. Further, processing may occur in any suitable fashion, as the invention is not limited to being implemented in any particular way. For example, processing may be performed in an automated, semi-automated or other fashion.

At the completion of act 330, process 300 completes.

It should be appreciated that techniques for determining the suitability of one or more investment products for an investor may be performed in any of numerous ways, and that the processes of FIGS. 1 and 3 are merely examples. Further, the processes of FIGS. 1 and 3 need not be performed in the particular ways described above. For example, acts in processes 100 and 300 may be performed in any suitable order and need not be performed in the sequence described above, additional acts may be performed, and/or some of the acts described above may be omitted. The invention is not limited to determining investment product suitability in any particular way.

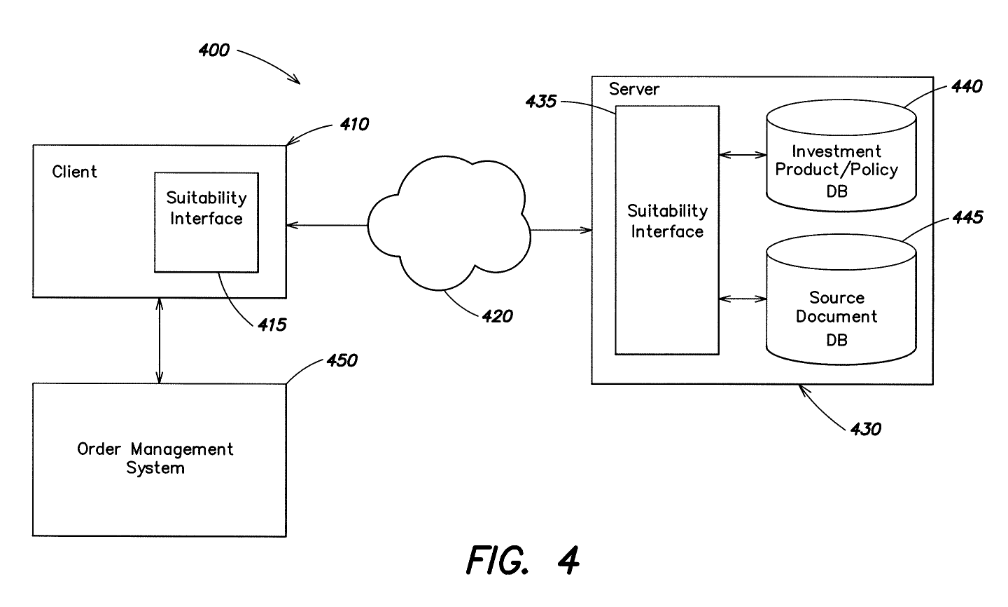

FIG. 4 depicts an example system 400 which may be employed to determine the suitability of one or more investment products for an investor. System 400 includes client 410, which communicates with server 430 via one or more networks 420. Each of client 410 and server 120 may comprise any one or more suitable computing devices, as the invention is not limited in this respect. As examples, client 410 may include any one or more personal computers, cellular telephones, personal digital assistants (PDAs) and/or other computing device, and server 430 may comprise any one or more servers, personal computers and/or other computing devices.

Client 410 executes suitability interface 415, which a user of client 410 may employ to provide information relating to one or more investors, and which may present information relating to the investor(s) and/or one or more investment products to the user. In some embodiments, suitability interface 415 is a graphical user interface. Suitability interface 415 communicates via networks 420 with suitability facility 435 executing on server 430. Suitability facility 435 may, for example, receive requests for information from suitability interface 415 via networks 420, and based on this information, execute queries on data stored in electronic file storage on server 430.

Server 430 includes investment product/policy database 440, which includes information on policies, rules, etc. for each of various investment products, and source document database 445, which includes materials providing more detailed information about the information stored in investment product/policy database 440. In some embodiments, when suitability interface 415 requests information on a particular investment product from suitability facility 435, suitability facility 435 queries investment product/policy database 440 and provides query results back to suitability interface 415 via network(s) 420. If a user of client 410 desires more detailed information relating to any investment product, the client may initiate a request for that detailed information via suitability interface 415, which is request received at suitability facility 435. Suitability facility 435 may then construct and execute a query on source document database 445, and provide the results of this query to suitability interface 415.

In example system 400, client 410 communicates with order management system 450 and enables a user of client 410 to initiate an order of one or more investment products deemed suitable for an investor. For example, after employing suitability interface 415 to evaluate different investment products, the user of client 410 may determine that one or more products is suitable for the investor, and may place an order (e.g., to initiate a purchase of the investment product, or to provide the investor with certain information, such as compliance information, about the product so that the investor may decide whether a purchase is appropriate).

Although order management system 450 is depicted in FIG. 4 as a component which is separate from client 410 and server 430, order management system 450 may include components (e.g., software modules) which execute on any one or more devices, such as client 410 and server 430. For example, one component of order management system 450 may include an interface which executes on client 410, and another component may be a module which executes on server 430, such that the modules communicate via networks 420.

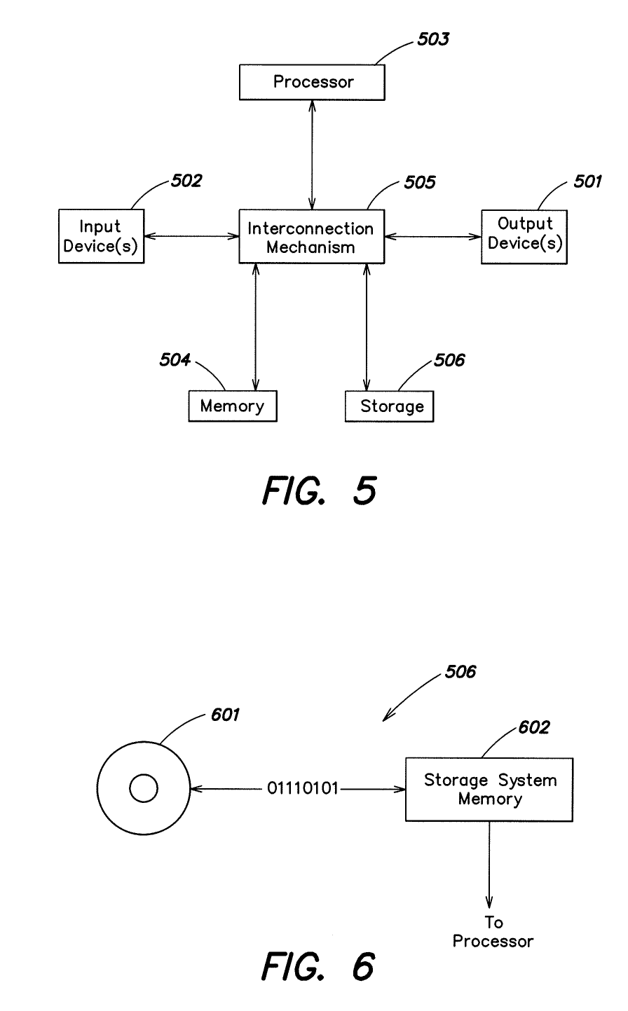

Various aspects of the systems and methods for practicing features of the invention may be implemented on one or more computer systems, such as the exemplary computer system 500 shown in FIG. 5. Computer system 500 includes input device(s) 502, output device(s) 501, processor 503, memory system 504 and storage 506, all of which are coupled, directly or indirectly, via interconnection mechanism 505, which may comprise one or more buses, switches, networks and/or any other suitable interconnection. The input device(s) 502 receive(s) input from a user or machine (e.g., a human operator), and the output device(s) 501 display(s) or transmit(s) information to a user or machine (e.g., a liquid crystal display). The processor 503 typically executes a computer program called an operating system (e.g., a Microsoft Windows-family operating system, or any other suitable operating system) which controls the execution of other computer programs, and provides scheduling, input/output and other device control, accounting, compilation, storage assignment, data management, memory management, communication and dataflow control. Collectively, the processor and operating system define the computer platform for which application programs and other computer program languages are written.

The processor 503 may also execute one or more computer programs to implement various functions. These computer programs may be written in any type of computer program language, including a procedural programming language, object-oriented programming language, macro language, or combination thereof. These computer programs may be stored in storage system 506. Storage system 506 may hold information on a volatile or non-volatile medium, and may be fixed or removable. Storage system 506 is shown in greater detail in FIG. 6.

Storage system 506 typically includes a computer-readable and writable nonvolatile recording medium 601, on which signals are stored that define a computer program or information to be used by the program. A medium may, for example, be a disk or flash memory. Typically, an operation, the processor 503 causes data to be read from the nonvolatile recording medium 601 into a volatile memory 602 (e.g., a random access memory, or RAM) that allows for faster access to the information by the processor 503 than does the medium 601. The memory 602 may be located in the storage system 506, as shown in FIG. 6, or in memory system 504, as shown in FIG. 5. The processor 503 generally manipulates the data within the integrated circuit memory 504, 602 and then copies the data to the medium 601 after processing is completed. A variety of mechanisms are known for managing data movement between the medium 601 and the integrated circuit memory element 504, 602, and the invention is not limited thereto. The invention is also not limited to a particular memory system 504 or storage system 506.

Having thus described several aspects of at least one embodiment of this invention, it is to be appreciated that various alterations, modifications, and improvements will readily occur to those skilled in the art. Such alterations, modifications and improvements are intended to be part of this disclosure, and are intended to be within the spirit and scope of the invention. Accordingly, the forgoing description and drawings are by way of example only.

Further, it should be appreciated that a (client or server) computer may be embodied in any of a number of forms, such as a rack-mounted computer, a desktop computer, a laptop computer, or a tablet computer. Additionally, a (client or server) computer may be embedded in a device not generally regarded as a computer but with suitable processing capabilities, including a Personal Digital Assistant (PDA), a smart phone or any other suitable portable or fixed electronic device.

Also, a (client or server) computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface including keyboards, and pointing devices, such as mice, touch pads, and digitizing tables. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks. Also, the various methods or processes outlined herein may be coded as software that is executable on one or more processors that employ any one of a variety of operating systems or platforms.

Additionally, such software may be written using any of a number of suitable programming languages and/or conventional programming or scripting tools, and also may be compiled as executable machine language code or intermediate code that is executed on a framework or virtual machine.

In this respect, the invention may be embodied as a computer-readable medium (or multiple computer readable media) (e.g., a computer memory, one or more floppy disks, compact disks, optical disks, magnetic tapes, flash memories, circuit configurations in Field Programmable Gate Arrays or other semiconductor devices, or other computer storage media) encoded with one or more programs that, when executed on one or more computers or other processors, perform methods that implement the various embodiments of the invention discussed above. The computer-readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be provided in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A computer-implemented method for evaluating the suitability of at least one investment product for an investor, comprising acts of:
(A) receiving information defining at least one characteristic of the investor;
(B) receiving information defining, for at least one investment product, at least one policy pertaining to investors in the at least one investment product;
(C) processing the information received in the acts (A) and (B) to determine whether and/or how at least one policy applies to the investor;
(D) presenting, to a user, an indication of whether and/or how the at least one policy applies to the investor.

2. The method of claim 1, wherein the at least one characteristic of the investor is selected from a group of characteristics comprising an amount to be invested, an account type, a desired rate of return, risk tolerance, investment purpose, an investment horizon, a plan for future periodic investment, a right of accumulation, an amount held with an investment firm, a letter of intent to invest amounts over a predetermined period, and an investor circumstance allowing a fee to be waived.

3. The method of claim 1, wherein the at least one policy defines whether and/or how one or more loads and/or fees and/or expenses apply to the at least one investment product, and/or provides an indication whether and/or how investor rights of accumulation, letters of intent, and/or waivers apply to the at least one investment product.

4. The method of claim 1, wherein the act (A) further comprises receiving the information defining the at least one characteristic of the investor from the user via a graphical user interface (GUI).

5. The method of claim 1, wherein the act (B) involves retrieving information defining at least one policy pertaining to investors in the at least one investment product from an electronic file storage.

6. The method of claim 1, wherein the act (D) further comprises presenting the indication of whether and/or how the at least one policy applies to the investor via a GUI.

7. The method of claim 1, wherein the at least one investment product comprises at least one share class of a mutual fund.

8. The method of claim 1, wherein the at least one investment product does not comprise at least one share class of a mutual fund.

9. The method of claim 1, wherein the at least one investment product comprises a share class of a first mutual fund and a share class of a second mutual fund.

10. The method of claim 1, wherein the at least one investment product comprises a share class of a mutual fund and at least one other investment product.

11. The method of claim 1, wherein the at least one investment product is selected from a group of investment products comprising a mutual fund, a stock, a bond, a variable annuity, a 529 plan, an educational investment or savings plan, an exchange traded note, an exchange traded fund, a unit investment trust, and Uniform Gift to Minors Act (UGMA) plan.

12. The method of claim 1, wherein the at least one investment product comprises at least two investment products, and the method further comprises act of:
(E) receiving from the user an indication that one of the at least two investment products is suitable for the investor.

13. The method of claim 12, further comprising an act of:
(F) receiving from the user an indication that the one investment product should be purchased for the investor and/or that compliance information should be ordered for the investor.

14. At least one computer-readable medium having instructions encoded thereon which, when executed by a computer, perform a method for evaluating the suitability of at least one investment product for an investor, comprising acts of:
(A) receiving information defining at least one characteristic of the investor;
(B) receiving information defining, for at least one investment product, at least one policy pertaining to investors in the at least one investment product,
(C) processing the information received in the acts (A) and (B) to determine whether and/or how at least one policy applies to the investor;
(D) presenting, to a user, an indication of whether and/or how the at least one policy applies to the investor.

15. The at least one computer-readable medium of claim 14, wherein the at least one characteristic of the investor is selected from a group of characteristics comprising an amount to be invested, an account type, a desired rate of return, an investment horizon, a plan for future periodic investment, risk tolerance, investment purpose, a right of accumulation, an amount held with an investment firm, a letter of intent to invest amounts over a predetermined period, and an investor circumstance allowing a fee to be waived.

16. The at least one computer-readable medium of claim 14, wherein the at least one policy defines whether and/or how one or more loads and/or fees and/or expenses apply to the at least one investment product, and/or provides an indication whether and/or how investor rights of accumulation, letters of intent, and/or waivers apply to the at least one investment product.

17. The at least one computer-readable medium of claim 14, wherein the act (A) further comprises receiving the information defining the at least one characteristic of the investor from the user via a graphical user interface (GUI).

18. The at least one computer-readable medium of claim 14, wherein the act (B) involves retrieving information defining at least one policy pertaining to investors in the at least one investment product from an electronic file storage.

19. The at least one computer-readable medium of claim 14, wherein the act (D) further comprises presenting the indication of whether and/or how the at least one policy applies to the investor via a GUI.

20. The at least one computer-readable medium of claim 14, wherein the at least one investment product comprises at least one share class of a mutual fund.

21. The at least one computer-readable medium of claim 14, wherein the at least one investment product does not comprise at least one share class of a mutual fund.

22. The at least one computer-readable medium of claim 14, wherein the at least one investment product comprises a share class of a first mutual fund and a share class of a second mutual fund.

23. The at least one computer-readable medium of claim 14, wherein the at least one investment product comprises a share class of a mutual fund and at least one other investment product.

24. The at least one computer-readable medium of claim 14, wherein the at least one investment product is selected from a group of investment products comprising a mutual fund, a stock, a bond, a variable annuity, a 529 plan, an educational investment or savings plan, an exchange traded note, an exchange traded fund, a unit investment trust, and Uniform Gift to Minors Act (UGMA) plan.

25. The at least one computer-readable medium of claim 14, wherein the at least one investment product comprises at least two investment products, and the method further comprises an act of:
(E) receiving from the user an indication that one of the at least two investment products is most suitable for the investor.

26. The at least one computer-readable medium of claim 25, further comprising an act of:
(F) receiving from the user an indication that the one investment product should be purchased for the investor and/or that compliance information should be ordered for the investor.

27. A system operable to evaluate the suitability of at least one investment product for an investor, the system comprising:
a suitability interface operable to receive information defining at least one characteristic of the investor;
a suitability facility operable to receive information defining, for at least one investment product, at least one policy pertaining to investors in the at least one investment product; and
at least one processing component operable to process at least some of the information defining the at least one characteristic of the investor and at least some of the information defining the at least one policy to determine whether and/or how at least one policy applies to the investor;
wherein the suitability interface is further operable to present, to a user, an indication of whether and/or how the at least one policy applies to the investor.

28. The system of claim 27, wherein the at least one characteristic of the investor is selected from a group of characteristics comprising an amount to be invested, an account type, a desired rate of return, risk tolerance, investment purpose, an investment horizon, a plan for future periodic investment, a right of accumulation, an amount held with an investment firm, a letter of intent to invest amounts over a predetermined period, and an investor circumstance allowing a fee to be waived.

29. The system of claim 27, wherein the at least one policy defines whether and/or how one or more loads and/or fees and/or expenses apply to the at least one investment product, and/or provides an indication whether and/or how investor rights of accumulation, letters of intent, and/or waivers apply to the at least one investment product.

30. The system of claim 27, wherein the suitability interface presents a graphical user interface (GUI) to receive the information defining the at least one characteristic of the investor from the user.

31. The system of claim 27, further comprising an electronic file storage from which is retrieved the information defining the at least one policy pertaining to investors in the at least one investment product.

32. The system of claim 27, wherein the suitability interface presents a GUI to present the indication of whether and/or how the at least one policy applies to the investor.

33. The system of claim 27, wherein the at least one investment product comprises at least one share class of a mutual fund.

34. The system of claim 27, wherein the at least one investment product does not comprise at least one share class of a mutual fund.

35. The system of claim 27, wherein the at least one investment product comprises a share class of a first mutual fund and a share class of a second mutual fund.

36. The system of claim 27, wherein the at least one investment product comprises a share class of a mutual fund and at least one other investment product.

37. The system of claim 27, wherein the at least one investment product is selected from a group of investment products comprising of a mutual fund, a stock, a bond, a variable annuity, a 529 plan, an educational investment or savings plan, a Uniform Gift to Minors Act (UGMA) plan, an exchange traded note, an exchange traded fund, and a unit investment trust.

38. The system of claim 27, wherein the at least one investment product comprises at least two investment products, and the system is further operable to receive from the user an indication that one of the at least two investment products is suitable for the investor.

39. The system of claim 38, wherein the system is further operable to receive from the user an indication that the one investment product should be purchased for the investor and/or that compliance information should be ordered for the investor.

40. A method comprising:
receiving suitability information about an investor; and
using a processor, identifying, based on at least some of the suitability information, at least one investment product suitable for the investor.

41. A method as claimed in claim 40 further including listing the at least one investment product.

42. A method as claimed in claim 41 wherein listing includes graphically displaying the at least one investment product.

43. A method as claimed in claim 40 wherein the at least one investment product includes at least two investment products; and further including enabling a comparison of the at least two investment products.

44. A method as claimed in claim 40 further including saving the investor suitability information.

45. A method as claimed in claim 40 wherein the investor suitability information is received through a first interface, and further including a second interface, further including communicating about investor suitability information and/or at least one investment product between the first and second interfaces.

46. A method as claimed in claim 1, wherein the user is the investor.

47. The at least one computer-readable medium of claim 14, wherein the user is the investor.

48. The system of claim 27, wherein the user is the investor.

49. A method as claimed in claim 1, wherein the user is a broker.

50. The at least one computer-readable medium of claim 14, wherein the user is a broker.

51. The system of claim 27, wherein the user is a broker.

52. A method as claimed in claim 1, wherein the user is an investment advisor.

53. The at least one computer-readable medium of claim 14, wherein the user is an investment advisor.

54. The system of claim 27, wherein the user is an investment advisor.
